(19) United States
(12) Patent Application Publication
(10) Pub. No.: US 2009/0220392 A1
(43) Pub. Date: Sep. 3, 2009

(54) INTEGRATED PROCESSES FOR GENERATING CARBON MONOXIDE FOR CARBON NANOMATERIAL PRODUCTION

(76) Inventors: Kevin McKeigue, Berkeley Heights, NJ (US); Weibin Jiang, Aurora, CO (US); Ramachandran Krishnamurthy, Chestnut Ridge, NY (US)

Correspondence Address: The BOC Group, Inc., 575 MOUNTAIN AVENUE, MURRAY HILL, NJ, 07974-2082, US

(21) Appl. No.: 12/435,444

(22) Filed: May 5, 2009

Related U.S. Application Data
(62) Division of application No. 11/974,953, filed on Oct. 17, 2007.
(60) Provisional application No. 60/933,600, filed on Jun. 6, 2007.

(51) Int. Cl. B01J 8/04

(52) U.S. Cl. 422/189; 977/742

(57) ABSTRACT

The integrated processes of the dry reforming or partial oxidation upstream of the carbon nanotube-producing reactor are described allowing the carbon monoxide to be produced on an as-needed basis, negating the need to transport carbon monoxide to the production site or store large quantities of carbon monoxide on-site. The apparatuses allowing to carry out such integrated processes are also provided. Carbon dioxide emissions may be eliminated from the carbon nanotube production process. This may be achieved by recycling the carbon dioxide byproduct and mixing it with the feed to the partial oxidation process.

### CROSS-REFERENCE TO RELATED APPLICATIONS

This application claims priority under 35 U.S.C. §119(e) to U.S. Patent Application Ser. No. 60/933,600 filed Jun. 6, 2007, which is herein incorporated by reference in its entirety.

### TECHNICAL FIELD

This disclosure relates generally to the processes for manufacturing carbon nanomaterials, and more specifically, to an integrated process for generating carbon monoxide based on a partial oxidation of the co-feedstock and manufacturing carbon nanomaterials using so generated carbon monoxide.

### BACKGROUND INFORMATION

Various carbon nanomaterials including single-walled carbon nanotubes, multi-walled carbon nanotubes and carbon nanofibers may be produced from carbon monoxide via the Boudart reaction using a suitable commercial process. Such a process may include supplying carbon monoxide and a catalyst precursor gas that is kept below the catalyst precursor decomposition temperature to a mixing zone. Another process that is available includes producing carbon nanotubes by contacting, in a reactor cell, metallic catalytic particles with an effective amount of carbon-containing gas at a temperature sufficient to catalytically produce carbon nanotubes. The resulting carbon nanotubes comprise substantial portion of the single-walled carbon nanotubes, and the metallic catalytic particle that may be used include a Group VIII metal or a Group VIb metal. Other processes utilizing the Boudart reaction may be also used to produce carbon nanomaterials.

The above-described processes are characterized by certain drawbacks and deficiencies. For example, the storage and handling of the highly toxic and flammable carbon monoxide feed gas creates numerous safety concerns. In addition, such processes typically lead to the emission of large quantities of greenhouse gases, such as about four tons of the carbon dioxide, for each ton of carbon nanomaterials produced.

To avoid or lessen the effects of the above-mentioned deficiencies₇ as welt as for the purposes of improvement of the overall process efficiency, better processes are needed to be used for producing carbon nanomaterials.

### SUMMARY

In several embodiments, methods for obtaining carbon nanomaterials are provided. One method comprises combining a hydrocarbon stream, a carbon dioxide stream and an oxygen stream to form a combined stream and, in a conversion reactor, subjecting the hydrocarbon in the combined stream to a process of conversion to form a converted gas stream comprising hydrogen, carbon monoxide, carbon dioxide, an unreacted portion of oxygen and an unreacted portion of the hydrocarbon, followed by removing the unreacted portion of oxygen from the converted gas stream by subjecting the converted gas stream to deoxydation to produce a deoxygenated gas stream comprising the hydrogen, the carbon monoxide, the carbon dioxide and the unreacted portion of the hydrocarbon. The step of removing the unreacted portion of oxygen may be carried out in a deoxydation apparatus.

Hydrogen may then be separated from the deoxygenated gas stream, for example, using a one- or a multi-stage membrane separator, or alternatively, using a pressure-swing adsorption process to form a principal stream, and a by-product stream, wherein the principal stream comprises the carbon monoxide, the carbon dioxide and the unreacted portion of the hydrocarbon, and the by-product stream comprises the hydrogen.

The principal stream may then be directed to a carbon nanomaterial production unit to produce carbon nanomaterials and carbon dioxide and the carbon monoxide may be recycled and directed to the conversion reactor. Alternatively, the principal stream may be subject to further separation to remove the majority of the carbon dioxide and the unreacted portion of the hydrocarbon to form a substantially pure carbon monoxide stream which may then be directed to a carbon nanomaterial production unit. Such purification of the principal stream will be desirable to produce certain types of carbon nanomaterials, particularly single-walled carbon nanotubes.

Other methods for separating the deoxygenated gas stream are also available including but not limited to cryogenic separation processes. In an embodiment, the method for separating this stream will depend strongly on the scale of production and the carbon monoxide purity required for the carbon nanomaterial production process.

In an embodiment, this invention provides an apparatus for producing carbon nanomaterials comprising a conversion reactor that converts a mixture of a hydrocarbon(s), carbon dioxide and oxygen into a converted gas stream comprising hydrogen, carbon monoxide, carbon dioxide, an unreacted portion of oxygen, and an unreacted portion of the hydrocarbon, and deoxydation unit, in fluid communication with the conversion reactor. The deoxydation unit may be used for removing the unreacted portion of oxygen from the converted gas stream and produces a deoxygenated gas stream comprising the hydrogen, the carbon monoxide, the carbon dioxide and the unreacted portion of the hydrocarbon.

The apparatus may further include a one- or a multi-stage membrane separator, in fluid communication with the deoxydation unit, for separating the hydrogen from the deoxygenated gas stream and forming a principal stream comprising the carbon monoxide, the carbon dioxide and the unreacted portion of the hydrocarbon.

In an embodiment, in lieu of the membrane separator, the apparatus may further include a pressure-swing adsorption unit or cryogenic separation unit in fluid communication with the deoxydation unit, for separating the hydrogen from the deoxygenated gas stream and forming a principal stream comprising the carbon monoxide, the carbon dioxide and the unreacted portion of the hydrocarbon.

The apparatus may further include a carbon nanomaterial production unit, in fluid communication with the membrane separator, wherein the carbon nanomaterial production unit produces carbon nanomaterials and the carbon dioxide stream, and the means for recycling the carbon monoxide, in fluid communication with the carbon nanomaterial production unit, for directing the carbon dioxide stream to the conversion reactor.

### BRIEF DESCRIPTION OF THE DRAWINGS

FIG. 1 illustrates schematically an apparatus for producing carbon nanomaterials according to one embodiment of the present invention.

FIG. 2 illustrates schematically an apparatus for producing carbon nanomaterials according to another embodiment of the present invention.

FIG. 3 illustrates schematically an apparatus for producing carbon nanomaterials according to yet another embodiment of the present invention.

### DETAILED DESCRIPTION

The following definitions and abbreviation are used below, unless otherwise described:

The term “a single-walled carbon nanotube” is defined as a hollow, substantially cylindrical tube made of a substantially chemically pure carbon and having a diameter between about 0.4 and about 4 nanometers.

The term “a multi-walled carbon nanotube” is defined as a co-axial arrangement of closely-spaced substantially cylindrical tubes made of a substantially chemically pure carbon and having an outer diameter between about 3 and about 100 nanometers.

The term “a carbon nanotube” refers to both single-walled carbon nanotubes and multi-walled carbon nanotubes.

The term “a carbon nanofiber” is defined as a substantially cylindrical structure having a diameter between about 1 and 100 nanometers made of substantially chemically pure carbon in a stacked arrangement of closely-spaced truncated cones.

The term “a carbon nanomaterial” is defined as structure made of substantially chemically pure carbon which has a size of less than 100 nanometers in at least one direction. Carbon nanomaterials include: fullerenes, single-walled carbon nanotubes, multi-walled carbon nanotubes, carbon nanohorns, carbon nanofibers, and single and multi-layer graphite platelets.

The term “a hydrocarbon” is defined as an organic compound, the molecule of which consists only of carbon and hydrogen.

The term “a catalyst” is defined as substance that changes the speed or yield of a chemical reaction without being itself substantially consumed or otherwise chemically changed in the process.

The term “a noble metal” refers to a metal that is highly resistant to corrosion or oxidation, and does not easily dissolve, as opposed to most base metals. Examples include, but are not limited to, platinum, palladium, gold, silver, tantalum, or the like.

The team “a base metal” refers to any non-precious metal that is capable of being readily oxidized. Examples include, but are not limited to, nickel, molybdenum, tungsten, cobalt, or the like.

The term “Boudart reaction” refers to the following chemical reaction (I):

2 CO→C+CO₂ (I)

The term “reforming” refers to a chemical process wherein molecules are chemically recombined (reformed), by using heat, pressure, typically, in the presence of a catalyst to form a different product.

The term “dry reforming” refers to a process of reforming a compound, for example, a hydrocarbon such as methane, using carbon dioxide, producing syngas.

The term “steam reforming” refers to a process of reforming a compound, for example, a hydrocarbon such as methane, using water, producing syngas.

The term “syngas” is an abbreviation of the term “synthesis gas” and refers to a gas mixture that contains varying amounts of carbon monoxide and hydrogen.

The term “partial oxidation” is one type of dry reforming and refers to a process of converting hydrocarbon(s) containing gases to a mixture of hydrogen, carbon monoxide and additional trace components such as carbon dioxide, water, and other hydrocarbons, by injecting preheated hydrocarbon(s) and an oxygen into a combustion chamber where oxidation of the hydrocarbon(s) occurs with a less than stoichiometric amount of oxygen needed for complete combustion.

The term “catalytic partial oxidation” refers to partial oxidation that is carried out in the presence of a catalyst such as noble metals, such as platinum, palladium or rhodium, or a base transition metal, such as nickel, on a suitable support structure.

The term “cold box” refers to a device containing cryogenic process equipment such as heat exchangers and distillation columns that can be used for separating a mixture of at least carbon monoxide and hydrogen into individual streams of carbon monoxide and hydrogen. If low molecular weight hydrocarbons are present in the mixture, they can also be separated using this device.

The term “membrane” refers to a thin barrier that allows some species present in a fluid mixture to pass through at greater rates than other species.

The term “pressure-swing adsorption” refers to a separation process in which An adsorbent is used to preferentially adsorb at least one species of a fluid mixture at an elevated pressure and to release at least a portion of the adsorbed material at a lower pressure.

### DETAILED DESCRIPTION

Incorporation of the reforming or partial oxidation processes upstream of the carbon nanomaterial-producing reactor allows the carbon monoxide to be produced on an as-needed basis, negating the need to transport carbon monoxide to the production site or store large quantities of carbon monoxide on-site. In the integrated process, nearly all of the carbon dioxide emissions may be eliminated from the carbon nanotube production process. This may be achieved by recycling the carbon dioxide byproduct and mixing it with the feed to the partial oxidation process. The integrated process may be more suited to various scale or distributed production plants, including those where the relatively small amount of hydrogen by-product would otherwise make its purification and compression uneconomical.

Syngas may be obtained by the process of dry reforming of a hydrocarbon, such as methane. Various hydrocarbons may be used, and the process of dry reforming using such hydrocarbons are known in the art. One possible pathway of dry reforming, i.e., partial oxidation, can be illustrated schematically by the reaction (II):

2 CH₄+CO₂+O₂→3 CO+3 H₂+H₂O (II)

More specifically, the process of partial oxidation shown by the reaction (II) is typically carried out at an elevated temperature, for example, at a temperature between about 700° C. and about 1,400° C., and at an elevated pressure, for example, at a pressure up to about 150 atmospheres. The process may be carried out in the presence of a catalyst. An appropriate catalyst can be selected from a variety of available options known in the art. For example, the catalyst that can be used may comprise a noble metal, for example, platinum, palladium, or rhodium, or, alternatively a transitional base metal, such as nickel. The metal may be embedded into a porous carrier, such as alumina or zeolite.

A variety of conditions may be used for carrying out the process of partial oxidation illustrated by the reaction (H). The most appropriate conditions for partial oxidation, i.e., the temperature, pressure, catalyst, and hydrocarbon/oxygen ratio may be selected. For example, a temperature above about 1,000° C., such as about 1,300° C., and a pressure of a up to 150 atmospheres may be used.

The syngas produced as shown by the reaction scheme (II) may include hydrogen, carbon monoxide, remaining unreacted carbon dioxide, and remaining unreacted oxygen. This mixture may be further processed to obtain purified carbon monoxide by removing all other components, i.e., hydrogen, unreacted carbon dioxide, and unreacted oxygen. The process of purification may be described as follows.

The unreacted portion of oxygen may be removed from the syngas stream by deoxydizing the syngas stream using the process of partial oxidation. The appropriate process and equipment needed to carry out the process of deoxydation may be selected from among many known options. As a result, a deoxygenated gas stream comprising hydrogen, carbon monoxide, and carbon dioxide may be formed.

Hydrogen may be separated from the deoxygenated gas stream to form a principal stream comprising the carbon monoxide, the carbon dioxide and the unreacted portion of the hydrocarbon, and a by-product stream comprising hydrogen. Such separating of hydrogen from the deoxygenated syngas may be accomplished by separation using a membrane.

An appropriate membrane may be selected. Various membranes, including polymeric, metallic porous support, etc., may be used, and the membranes are known in the art. The membrane may comprise a thin silicon dioxide Layer deposited on a porous alumina support. The pores may have a diameter between about 5 and about 10 nanometers. The silicon dioxide layer can be formed over the alumina substrate by chemical vapor deposition of tetraethylorthosilicate, at a temperature between about 600° C. and 650° C., in the argon atmosphere, until the desired degree of hydrogen permeability has been reached. The hydrogen so separated from the carbon monoxide stream need not be further purified. Instead, it may be optionally recovered and exported for use as a fuel, as discussed below.

After hydrogen has been separated as discussed above, the principal stream comprising the carbon monoxide, the carbon dioxide and the unreacted portion of the hydrocarbon may be directed to a carbon nanomaterial production unit to produce carbon nanomaterials and the carbon dioxide stream using the Boudart reaction (I) shown above. The carbon dioxide stream, which includes that formed as a result of the Boudart reaction, may be recycled and used in partial oxidation. The conditions that are necessary for carrying out the Boudart reaction to make the carbon nanomaterials are known in the art and those having ordinary skill in the art may select the optimal conditions.

Depending upon the specific type, size and purity of carbon nanomaterial desired, it may be desirable to remove the carbon dioxide and the unreacted portion of the hydrocarbon from the principal stream and feed substantially pure carbon monoxide to the carbon nanomaterial production unit. This may accomplished by any of several available methods including: membrane processes, pressure-swing adsorption processes, absorption processes, etc. in each case, the purified carbon monoxide stream may be directed to the carbon nanomaterial production unit and the carbon dioxide and hydrocarbon streams may be recycled to the reformer unit.

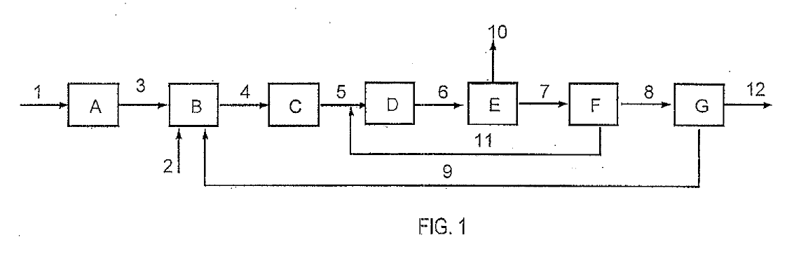

Turning now to FIG. 1, hydrocarbon 1 is directed to the pretreatment reactor A. The hydrocarbon pretreatment reactor unit permits sulfur removal, allows to saturate various olefins that may be present, and optionally to pre-reform hydrocarbon 1. After exiting the pre-treatment reactor A, the hydrocarbon enters into the hydrocarbon conversion reactor B via line 3. The hydrocarbon conversion reactor B may be a catalytic partial oxidation apparatus for carrying out the process of catalytic partial oxidation. The hydrocarbon conversion reactor B may also be an autothermal catalytic reformer, or a non-catalytic partial oxidation apparatus, for carrying out the process of autothermal catalytic reforming, or the process of non-catalytic partial oxidation, respectively.

The hydrocarbon stream 3, oxygen stream 2 and recycled carbon dioxide gas stream 9 may all be directed to the hydrocarbon conversion reactor B, where the process of conversion can be carried out at a temperature of between about 700° C. and about 1,400° C., and a pressure of up to 150 atmospheres, optionally, in the presence of an appropriate catalyst.

The reaction products then exit the hydrocarbon conversion reactor B via line 4. The gas stream may comprise hydrogen, carbon monoxide, carbon dioxide, unreacted oxygen, unreacted hydrocarbon, such as methane, and water. After various heat recovery process, this gas stream 4 is directed to deoxygenation unit C to remove trace amount of unreacted oxygen. Then the gas stream 5, combined with recycled stream 11 from second stage membrane F is compressed through compression unit D, and directed to the first stage membrane unit E through line 6. The permeated waste gas stream 10 may contain the majority of the hydrogen and can be exported as fuel. The relatively higher pressure carbon monoxide rich stream 7 is directed to second stage membrane unit F to produce higher purity carbon monoxide stream, which is further used as feed stock 8 for carbon nanomaterial production unit G to produce carbon nanomaterials. The carbon dioxide byproduct stream 9 from nanocarbon production unit G is then recycled back to hydrocarbon conversion unit B.

The nanocarbon production unit G may comprise several sub-units including a nanocarbon production reactor, a separator for separating the solid nanocarbon product from the effluent gas stream, a device for separating and recycling unreacted feed gas, and optionally a device for separating undesirable by-products from the carbon dioxide by-product stream.

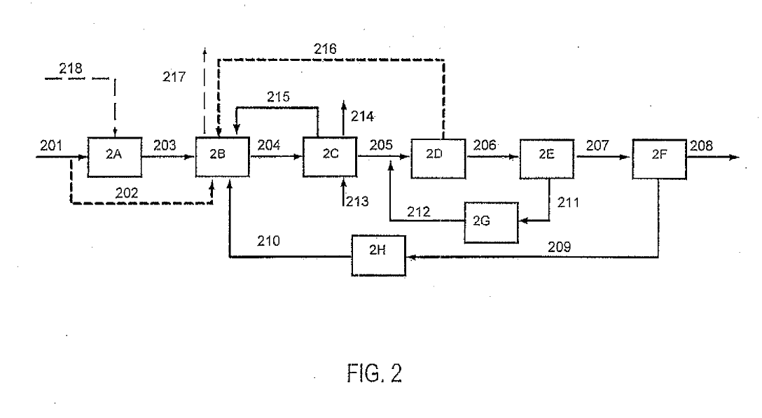

Turning now to FIG. 2, syngas may be obtained by the process of dry reforming of a hydrocarbon, such as methane, but without the use of oxygen. One possible pathway of oxygen-free dry reforming can be illustrated schematically by the reaction (III):

CH₄+CO₂→2 CO+2 H₂ (III)

More specifically, the process of dry reforming shown by the reaction (III) is typically carried out at an elevated temperature, for example, at a temperature between about 700° C. and about 1,000° C., and at an elevated pressure, for example, at a pressure up to about 150 atmospheres. The process may be carried out in the presence of a catalyst. An appropriate catalyst can be selected from a variety of known options. For example, a catalyst that can be used may comprise a noble metal, for example, platinum, palladium, or rhodium, or, alternatively a transitional base metal, such as nickel. The metal may be embedded into a porous carrier, such as alumina or zeolite.

In practice, for optimal operability of the reformer unit and to avoid coke formation on the process equipment, a combination of dry and steam reforming may optionally be used. One possible pathway of steam reforming can be illustrated schematically by the reaction (IV):

CH₄+H₂O→CO+3 H₂ (IV)

Optimal conditions (i.e., temperature, pressure, catalyst) to be utilized for the steam reforming, if used, may be selected. For carbon nanomaterial production, it is desirable to maximize the amount of carbon monoxide produced in the reformer and minimize the amount of hydrogen produced. Therefore, the feed to the reformer may be include only as much steam as is required to avoid coke formation.

In one aspect of FIG. 2, the syngas produced as shown by the reaction scheme (III) includes hydrogen, carbon monoxide, remaining unreacted carbon dioxide, and remaining unreacted hydrocarbon. This mixture may be further processed to obtain purified carbon monoxide by removing all other components, i.e., hydrogen, unreacted carbon dioxide, and unreacted hydrocarbon to the extent desired. The process of purification may be described as follows.

Hydrogen and unreacted hydrocarbon may be removed leaving a principal stream comprising the carbon monoxide and the carbon dioxide, and a by-product stream comprising hydrogen and unreacted hydrocarbon. Such separating of hydrogen and unreacted hydrocarbon from the syngas may be accomplished by using one or plurality of membranes as described above. The membrane(s) can be the same as described with respect to FIG. 1. Alternatively, such separation may be accomplished using other suitable processes such as pressure-swing adsorption processes and/or cryogenic separation processes.

After hydrogen and unreacted hydrocarbon have been separated using the membrane(s), the principal stream comprising carbon monoxide, and the carbon dioxide may be directed to a carbon nanomaterial production unit to produce carbon nanomaterials and the carbon dioxide stream using the Boudart reaction (I) as discussed above. Alternatively, the carbon dioxide may be removed to the extent desired from the principal stream to produce a substantially pure carbon monoxide stream which may then be directed to the carbon nanomaterial production unit. The carbon dioxide stream (including the unreacted portion of the carbon dioxide that was present in the principal stream and the carbon dioxide formed as a result of the Boudart reaction) may be recycled and used in dry reforming or in the combined dry and steam reforming processes, as discussed above.

This is described in more detail with the reference to FIG. 2. As can be seen from FIG. 2. Hydrocarbon 201 may be directed to the pretreatment reactor 2A. The hydrocarbon pretreatment reactor unit permits removal of sulfur, allows to saturate various olefins that may be present, and optionally allows to pre-reform hydrocarbon 201. A part of the untreated hydrocarbon stream 202 may supply fuel for the hydrocarbon conversion reactor 2B.

After exiting the pre-treatment reactor 2A, the hydrocarbon may enter into the hydrocarbon conversion reactor 2B via line 203. As shown by FIG. 2, the hydrocarbon conversion reactor 2B is adopted to carry out both carbon dioxide dry reforming process and catalytic steam reforming process. A variety of other hydrocarbon conversion reactors 2B can be selected if desired.

The hydrocarbon stream 203, steam 215 and recycled carbon dioxide gas stream 10 may enter the hydrocarbon conversion reactor 2B where the process of conversion can be carried out at a temperature of between about 700° C. and about 1,000° C., and a pressure of up to 150 atmospheres, optionally, in the presence of an appropriate catalyst. The reaction products may exit the hydrocarbon conversion reactor 2B as the gas stream 204.

In FIG. 2, the gas stream 204 comprises hydrogen, carbon monoxide, unreacted steam, unreacted carbon dioxide and unreacted hydrocarbon, such as methane. The gas stream 204 may be then directed to the heat recovery device 2C, comprising a process heat boiler, various heat exchangers and cooling tower (not shown) to cool down the gas stream 204 to required down stream temperature. Accordingly, the gas stream 205 may exit the heat recovery device 2C with the same chemical composition as the gas stream 204 but at a lower temperature than the gas stream 204. Process steam 215 and export steam 214 from water 213 may be produced in the process.

The gas stream 205 may then enter the first stage membrane unit 2D, where most of the hydrogen and carbon dioxide is separated from the rest of the gas stream, resulting in formation of two separate streams. These two streams are the principal stream 206 comprising the majority of the carbon monoxide along with a portion of the unreacted carbon dioxide and a portion of the unreacted hydrocarbon, and the permeated waste gas stream 216 comprising primarily hydrogen along with the majority of the unreacted carbon dioxide.

The permeated waste gas stream 216 may be then directed to hydrocarbon conversion unit 2B as fuel. The products from the combustion of the fuel may leave unit 2B through effluent stream 217. The relatively higher pressure carbon monoxide rich principal stream 206 may be then directed to second stage membrane unit 2E, where the carbon monoxide and the remaining unreacted carbon dioxide are further separated to produce higher purity carbon monoxide stream 207 and a carbon dioxide enriched permeate stream 211.

The carbon monoxide stream 207 may be further used as feed stock for carbon nanomaterial production unit 2F to produce carbon nanomaterials 208 and a waste carbon dioxide stream 209. The carbon dioxide enriched permeate stream 211 may be compressed through compression unit 2G and then recycled back into first stage membrane unit 2D through line 212, and the waste carbon dioxide stream 209 from carbon nanomaterial production unit 2F may be compressed and recycled via stream 210 into hydrocarbon conversion unit 2B through compression unit 2H.

In some instances, the carbon nanomaterial production unit 2F may comprise several sub-units (not shown) including a carbon nanomaterial production reactor, a device for separating the solid carbon nanomaterial product 208 from the effluent gas stream, a sub-unit for separating and recycling unreacted feed gas, and possibly a device for separating undesirable by-products from the carbon dioxide by-product stream.

Many variations of the apparatus and the process shown by FIG. 2 are possible. The heat required for the reformer can be generated by the combustion of a portion of the hydrogen product from the reformer. Alternatively, the hydrogen product can be sold and natural gas can be used to fuel the reformer. Additionally, the heat released by exothermic reaction in the carbon nanomaterial reactor unit 2F may be used to preheat the feed to the reformer thus reducing the amount of fuel required for the process.

In an embodiment, an additional amount of carbon dioxide can be imported from an external source and mixed with the feed to the reformer to achieve additional advantage. When the hydrocarbon fed to the reformer is methane, up to an equal molar amount of external carbon dioxide may also be fed to the reactor via stream 218. Under these conditions, the overall process can be illustrated schematically by the overall reaction (V):

CH₄+CO₂→2 C+2 H₂O (V)

This process provides a means for consuming carbon dioxide and thus preventing its release into the atmosphere where it is thought to be a significant contributor to global warming. As the overall reaction (V) is exothermic, with efficient energy integration of the various unit operations of the process, the combined production of carbon nanotubes and sequestration of externally produced carbon dioxide can be accomplished with little or no additional combustion of fossil fuels.

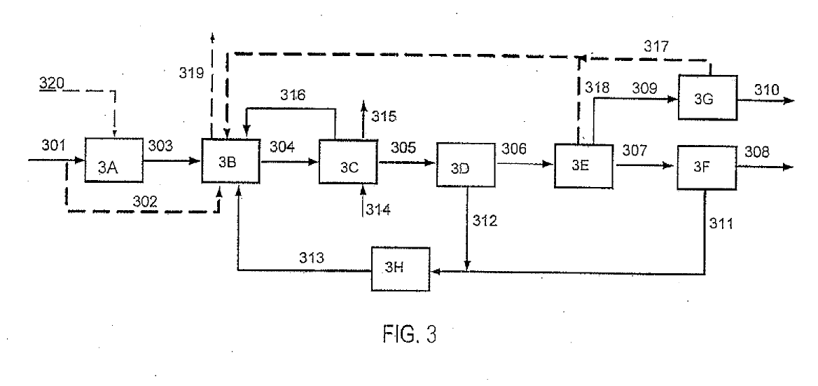

In other instances described with the reference to FIG. 3, syngas also may be obtained by the process of dry reforming shown by the reaction scheme (III). The process of dry reforming may substantially similar to that described with respect to FIG. 2, including the optional utilization of steam reforming. As before, the carbon dioxide by-product may be recycled and mixed with the feed to the reformer which increases the amount of carbon monoxide produced by the reformer.

However, some additional features may be used. These additional features may include the use of a cold box instead of a membrane separator for separating of hydrogen and unreacted hydrocarbon from the syngas. This feature may be used in large-scale production plants. Also, the process allows to produce hydrogen as a valuable co-product.

This can be described in more detail with the reference to FIG. 3. As can be seen from FIG. 3, hydrocarbon 301 may be directed to the pretreatment reactor 3A. Just as in FIG. 2, hydrocarbon pretreatment reactor 3A allows to remove sulfur, to saturate various olefins that may be present, and optionally pre-reform hydrocarbon 301. A part of the hydrocarbon stream 302 may supply fuel for the hydrocarbon conversion reactor 3B.

After exiting the pre-treatment reactor 3A, the hydrocarbon may enter into the hydrocarbon conversion reactor 3B via line 303. The hydrocarbon conversion reactor 3B in FIG. 3 is adopted to carry out both carbon dioxide dry reforming process and catalytic steam reforming process. A variety of other hydrocarbon conversion reactors 3B can be selected if desired.

The hydrocarbon stream 303, steam 316 and recycled carbon dioxide gas stream 313 may react within the hydrocarbon conversion reactor 3B at temperatures of between about 700° C. and about 1,000° C. The reaction products may exit the hydrocarbon conversion reactor 3B through tine 304. The gas stream 304 may comprise hydrogen, carbon monoxide, carbon dioxide and unreacted hydrocarbon, such as methane. This gas stream 304 may be then directed to the heat recovery device 3C. The heat recovery device 3C may also contain process heat boiler, various heat exchangers and cooling tower (not shown) to cool down the gas stream 304.

The gas stream 304 that has been cooled to a required down stream temperature may then enter the carbon dioxide removal unit 3D as the gas stream 305. The gas stream 305 exits the heat recovery means 3C with the same chemical composition as the gas stream 304 but at a lower temperature than that of the gas stream 304. The process steam 316 and the export steam 315 (from water 314) may be also generated in the heat recovery means 3C. In the carbon dioxide removal unit 3D, the carbon dioxide stream 312 and the depleted carbon dioxide stream 306 may be obtained from the gas stream 305.

The separated carbon dioxide gas 312 may be then directed to carbon dioxide compression unit 3H and then recycled into hydrocarbon conversion unit 3B as the stream 313. The depleted carbon dioxide stream 306 may travel to the carbon monoxide separation unit 3E to produce product the carbon monoxide stream 307 the and raw hydrogen stream 309. A typical carbon monoxide separation device that may be used can include a cold box, a membrane system or a pressure swing adsorption unit. The most appropriate carbon monoxide separation device may be selected. The waste gas stream 318 leaving carbon monoxide separation unit 3E may be recycled and used as fuel for the hydrocarbon conversion unit 3B. The effluent stream 319 may comprise the products from the combustion of the fuel supplied to the hydrocarbon conversion unit 3B.

Carbon monoxide 307 generated in the carbon monoxide separation unit 3E may be directed to the carbon nanomaterial production unit 3F. The waste carbon dioxide stream 311 from the carbon nanomaterial production unit 3F may be directed to the carbon dioxide compression unit 3H and then compressed stream may be directed to the hydrocarbon conversion reactor 3B. Stream 308 contains the solid nanocarbon product and may, for example, comprise solid carbon nanomaterial deposited on a screen or filter or, alternatively, may comprise a stream of effluent gas (such as e.g., carbon monoxide, carbon dioxide, etc.) enriched in the carbon nanomaterial product.

The nanocarbon production unit 3F may include several sub-units (not shown), such as a carbon nanomaterial production reactor, a device for separating the solid carbon nanomaterial product from the effluent gas stream, a device for separating and recycling unreacted feed gas, and possibly a device for separating undesirable by-products from the carbon dioxide by-product stream.

The raw hydrogen stream 309 may enter the pressure swing adsorption device 3G, which typically includes an adsorbent material. Usually, this adsorbent material is activated carbon or a zeolite 5A adsorbent material. The product of the pressure swing adsorption process may be hydrogen at high pressure, which will exit the unit 3G as stream 310. The remainder of the gas present in this stream will leave the unit 3G via line 317 and may be used as a fuel gas in the hydrocarbon conversion unit 3B.

Many variations of the-above described process may be devised. For example, the heat required for the reformer may be generated by the combustion of a portion of the hydrogen product from the reformer. Alternatively, the hydrogen product may be sold and natural gas can be used to fuel the reformer. Additionally, the heat released by exothermic reaction in the carbon nanomaterial reactor unit 3F may be used to preheat the feed to the reformer, thus reducing the amount of fuel required for the process.

In an embodiment, an additional amount of carbon dioxide can be imported from an external source and mixed with the feed to the reformer to achieve additional advantage. When the hydrocarbon fed to the reformer is methane, up to an equal molar amount of external carbon dioxide may also be fed to the reactor via stream 320. Under these conditions, the overall process can be illustrated schematically by the overall reaction (V). The addition of imported carbon dioxide to the reformer decreases the amount of hydrogen by-product produced by the process.

This process provides a means for consuming carbon dioxide and thus preventing its release into the atmosphere where it is thought to be a significant contributor to global warming. As the overall reaction (V) is exothermic, with efficient energy integration of the various unit operations of the process, the combined production of carbon nanotubes and sequestration of externally produced carbon dioxide can be accomplished with little or no additional combustion of fossil fuels.

All the process integration schemes discussed above may help eliminate virtually all of the carbon dioxide emissions from the carbon nanomaterial production process. It is also possible to import carbon dioxide to serve as a portion of the feed to the process. The integrated processes can, therefore, serve as effective methods of sequestering carbon dioxide in the form of a valuable product (carbon nanomaterials).

It will be understood that the processes and apparatuses described herein are merely exemplary, and that one skilled in the art may make variations and modifications without departing from the spirit and scope of this disclosure. All such variations and modifications are intended to be included within the scope of the disclosure as described hereinabove. Further, all representative examples that are disclosed are not necessarily in the alternative, as various aspects may be combined to provide the desired result. Accordingly, our disclosure is limited only by the following claims.

1-17. (canceled)

18. An apparatus for producing carbon nanotubes comprising:
a conversion reactor that converts a mixture of a hydrocarbon, carbon dioxide and oxygen into a converted gas stream comprising hydrogen, carbon monoxide, unreacted hydrocarbon, unreacted carbon dioxide, and unreacted oxygen;
a deoxydation unit, in fluid communication with the conversion reactor, for removing the unreacted oxygen from the converted gas stream to form a deoxygenated gas stream comprising the hydrogen, the carbon monoxide, the unreacted hydrocarbon and the unreacted carbon dioxide;
a separator, in fluid communication with the deoxydation unit, for separating the hydrogen from the deoxygenated gas stream to form a principal stream containing the carbon monoxide, and a by-product stream comprising the hydrogen;
a carbon nanotube production unit, in fluid communication with the separator, for producing carbon nanotubes from the carbon monoxide and a waste stream of carbon dioxide; and
means for recycling the waste stream from the carbon nanotube production unit to the conversion reactor.

19. The apparatus of claims 18, wherein the separator comprises at a first stage separator and a second stage separator wherein the first stage separator separates the deoxygenated gas stream into a principal stream comprising the carbon monoxide, the unreacted hydrocarbon and the unreacted carbon dioxide, and a by-product stream comprising the hydrogen and the second stage separator separates unreacted hydrocarbon from the principal stream to produce a purified principal stream containing the carbon monoxide and the unreacted carbon dioxide.

20. The apparatus of claim 19 wherein the first stage separator includes at least one membrane comprising a layer of an inorganic material deposited on a porous amorphous substrate.

21. The apparatus of claim 20, wherein the inorganic material comprises a layer of silicon dioxide.

22. (canceled)

23. The apparatus of claim 20, wherein the porous amorphous substrate comprises alumina.

24. The apparatus of claim 20, wherein the porous amorphous substrate has pores with a diameter between 5 and 10 nanometers.

25. The apparatus of claim 18 further comprising means for exporting the hydrogen from the separator.

26. The apparatus of claim 19 wherein the second stage separator is a membrane separator, a pressure swing adsorption unit or a cryogenic separation unit.

27. The apparatus of claim 18 wherein the conversion reactor is a catalytic reformer.

28. The apparatus of claim 18, wherein the hydrocarbon is methane.

29. The apparatus of claim 18 further comprising a pretreatment unit for removing sulfur and saturating olefins in the hydrocarbon.

30. The apparatus of claim 18 further comprising a compression unit fluidly connected between the deoxydation unit and the separator.

31. The apparatus of claim 18 wherein the carbon nanotube production unit comprises a carbon nanomaterial production reactor, means for separating solid carbon nanomaterial from the effluent gas stream, means for separating and recycling unreacted feed gas and means for separating by-products from the waste stream.
